(19) United States
(12) Patent Application Publication
(10) Pub. No.: US 2018/0235400 A1
(43) Pub. Date: Aug. 23, 2018

(54) Chafer rack wire bar and panel assembly

(71) Applicant: Darryl Thomas Jones, St. Louis, MO (US)

(72) Inventor: Darryl Thomas Jones, St. Louis, MO (US)

(21) Appl. No.: 14/998,553

(22) Filed: Jan. 20, 2016

(51) Int. Cl. A47J 36/24; A47J 27/10; A47J 36/26; A47J 36/34

(52) U.S. Cl. CPC A47J 36/2405; A47J 36/34; A47J 36/26; A47J 27/10

(57) ABSTRACT

An improved chafer rack and panel assembly having hingedly attached and removable wind-shield panels connected to integral wire bars of the chafer rack.

### BACKGROUND OF THE INVENTION

### 1. Field of the Invention

The invention relates generally to catering devices and in particular, to portable chafer dish assemblies for use in food service.

### 2. Description of the Prior Art

Chafers or chafing dishes are commonly used by restaurants and by catering services for serving food outdoors. A conventional chafer includes a wire rack or frame that contains a burner. A chafing dish tray is typically filled with water and is supported by the rack above the burner. Trays containing food are then placed into the chafing dish tray to be heated by the warmed water.

The burner produces a flame that is commonly generated by combusted petroleum based gel contained within a can, such as the fuel can manufactured under the trademark, STERNO. In outdoor settings, the open flame of the burner is susceptible to being extinguished by gusts of wind or drafts. Also, there is the risk of fire from open flames and fuel spills.

Oftentimes, multiple chafers are staged by caterers in either an end-to-end or a side-by-side alignment, especially when staging for purposes of buffet serving. There have been windshield boxes designed for housing chafer racks in order to shield the chafers from the wind. However such box designs are unduly bulky and onerous for portable catering needs. But moreover, they are quite unsuitable for staging multiple chafer racks when, due to limitations in spacing, flexibility is needed to properly stage the chafers. Caterers desire the flexibility of staging the chafers outdoors at either an end-to-end or side-by-side alignment.

Also, during outdoor events, the wind may suddenly change directions. The prior art box type designs do not offer an efficient and expedient means for rearranging the access ports to the burners, prior to the burners' flames being extinguished by winds blown from a direction opposite to that for which the original staging was designed to protect. In most cases, it is problematic to protect the two sides of a chafer simultaneously, while also protecting the two ends of the same or contiguously stationed chafers when staged in multiple chafer alignments.

Commercially available box type wind shields for outdoor use of chafers are available today and include for example the chafer shield from Randware and the Harris Products windscreen. The Randware design is believed to be the subject of U.S. Pat. No. 5,819,640. Each has the drawbacks referred to above. Also, the long felt need for protecting outdoor use of chafers from wind drafts has been established since at least as early as 1925 as disclosed in U.S. Pat. No. 1,701,989 issued to E. N. Turner. More recent developments are further disclosed in for example US Design 275,643 by Petterson; U.S. Design 305,972 by Pearce; and in U.S. Pat. Nos. 5,517,903 and 5,711,210 both issued to Kauffman; as well as a temperature controlled butane gas burning chafer dish as disclosed in U.S. Pat. No. 6,941,943 by Cahill, et. al. This long felt need however remains unsatisfied because the prior art devices have been either unduly cumbersome, too expensive, or they lack sufficient airflow to keep the flame lit, or they allow too much airflow to be universally acceptable to restaurants and caterers.

As will be described in greater detail hereinafter, the chafer and panel assembly of the present invention satisfies the aforesaid long felt needs while solving the drawbacks and problems of the prior art with improved efficiency and convenience. The invention is highly advantageous, lighter weight, more easily stored and transported, and generally more acceptable for purposes of portable chafer service and multiple chafer staging than are prior art chafer rack shield or windscreen assemblies.

### SUMMARY OF THE INVENTION

Accordingly, it is a feature of the present invention to provide a chafer rack and panel assembly which protects the STERNO flames from being extinguished by gusts of wind and air drafts which may emanate from multiple directions during the course of a single event, and while allowing the STERNO to be easily managed by the caterers, from either side or either end of the chafer rack and panel assembly.

Another feature of the assembly of the present invention allows protection for the chafers' flames while aligning multiple chafers either end-to-end or side-by-side.

To achieve the foregoing features, as well as other features which will become more apparent from the following description and appended drawings, and in accordance with the purposes of the present invention the improved chafer rack and panel assembly of the present invention is provided. The assembly comprises a wire chafer rack and at least two individual side and/or end panels that are removably hinged at one or more wire bars of the chafer rack frame.

### BRIEF DESCRIPTION OF THE DRAWINGS

FIG. 1 is an exploded perspective view of the chafer rack and panel assembly of the present invention;

FIG. 2 is a perspective view of a prior art chafer rack having a plurality of wire bars;

FIG. 3 is perspective view of an embodiment of the chafer rack and panel assembly of the present invention having windshield panels hingedly attached to and being removable from both horizontally and vertically positioned wire bars of the chafer rack and panel assembly of the present invention.

### DETAILED DESCRIPTION OF THE PREFERRED EMBODIMENTS

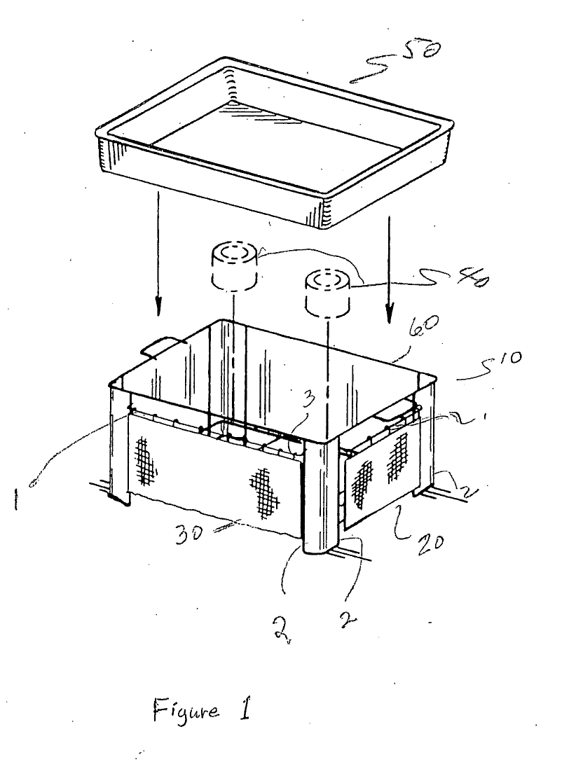

Referring now to the drawings, an improved chafer rack and panel assembly 10 is illustrated in FIG. 1 pursuant to a preferred embodiment of the present invention. The assembly 10 generally may include a wire frame or rack 60, defined by horizontally positioned wire bars 1 and vertically positioned bars 2 integral to said rack. Hingedly attached to and easily removable from at least one of the horizontal positioned wire bars 1 are end panel 20 and side panel 30. STERNOS 40 are insertable into the assembly 10 and used to produce the heat needed to warm the chafer dish tray or pan 50 which rests atop the assembly 10.

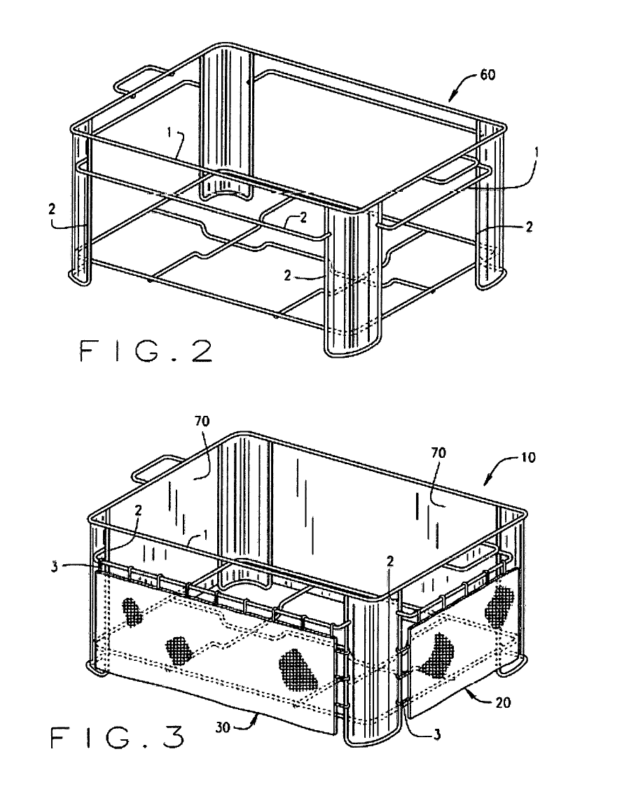

FIG. 2 more readily illustrates the frame or rack 60 well known in the prior art.

FIG. 3 illustrates in greater detail an individual chafer rack and panel assembly of the present invention. The connectors 3 allow for removably and hingedly attaching individual end panels 20 and/or side panels 30 along either a horizontal or vertical bar 1 or 2 so as to independently swivel and axially open or close from the respective wire bar of the rack without disturbing an adjacent panel. The connectors 3 in the illustrated embodiments are hooks, but could be substituted for by any of a variety of articles including for example small hinges or even a single sleeve of metal or other fire retardant material that is molded, bent, or formed to hingedly and individually attach to and be removable from one of the horizontal wire bars 1 and/or one of the vertical wire bars 2 which are integral to the wire rack. The panels 20 and 30 can be used o shield each of the two ends and/or each of the two sides. This enables greater flexibility, convenience, and efficiency over prior art chafers. The individual panels of the present invention permit deployment of chafers in a variety of different alignments. The particular alignment or orientation desired for using multiple chafer assemblies 10 when serving large crowds at for example picnics, outdoor banquets, or other gatherings may vary depending upon the spacing, or other environmental conditions including the prevailing direction of the wind. If end-to-end staging is desired, then chafer side panels 30 can be attached to the sides of the interior aligned chafers 60 while the chafers at the very terminal points of the alignment will need side panels 20. And, of course, vice versa if the chafers, rather than being staged in end-to-end alignment, are aligned side-by-side, then end panels 20 are attached to each of the two ends of each chafer rack assemblies 10 staged along the interior of the side-to-side alignment, while side panels 30 would be attached to the terminal sides for the first and last chafer assemblies 10 being staged in that manner.

The alternative embodiment of the invention as displayed in FIG. 3, allows for modification of rack member 60 illustrated in FIG. 2. Such embodiment calls for one side and/or one end of rack 60 to be defined as solid wall or walls 70 rather than integral wire bars. The wall members 70 would be, preferably, substantially transparent as for example made from flame retardant, treated glass or plexiglass to enable viewing the flame. The wall member 70 maybe of varying dimensions, fixed, movable, or removable if desired. However, wall members 70 are not critical embodiments. In fact, no more than 2 wall members is within the scope of the present invention.

The panels 20/30 of the invention can be manufactured from any fire retardant material with sufficient strength and integrity to be hingedly attached to and removable from the wire racks. Preferably sheet metal, metal foil, or fire retardant composite materials are used as materials of construction. Some specially designed fabrics could also be employed if desired.

Although the invention has been described by reference to particular embodiments, it is not intended that the novel device should be limited thereby, but that modifications thereof are intended to be included as falling within the broad scope and spirit of the foregoing disclosure, the following claims, and the appended drawings.

What is claimed is:

1. An improved chafer rack assembly of the type defined by a plurality of integral connected horizontal and vertical positioned wire bars and having two sides and two ends;
the improvement comprising at least two independent panels, selected from the group consisting of an end and a side wind-shield panel, hingedly attached to said wire bars so as to each axially and independently open and close from their respective bars without disturbing the other panel.

2. The improved rack of claim 1 wherein the wind-shield panels are removable from the wire bars.

3. The improved rack and panel assembly of claim 1 wherein the wind-shield panels are hingedly attached to and removable from horizontally positioned wire bars.

4. The improved rack and panel assembly of claim 1 wherein the panels are hingedly attached to and removable from vertical positioned wire bars.

5. The improved rack and panel assembly of claim 1 wherein at least one of the wind-shield panels is hingedly attached to and removable from both a vertical and a horizontally positioned wire bar.

6. The improved rack and panel assembly of claim 1 wherein the panels are made of material selected from the group consisting of sheet metal, metal foil, and fire retardant composite material.

7. The improved rack and panel assembly of claim 1 wherein at least one end is a solid wall.

8. The improved rack and panel assembly of claim 1 wherein at least one side is a solid wall.

9. The improved rack and panel assembly of the claim 1 wherein one side and one end are solid walls.
